(19) United States
(12) Patent Application Publication
(10) Pub. No.: US 2026/0310821 A1
(43) Pub. Date: Oct. 8, 2026

(54) INFORMATION PROCESSING DEVICE

(71) Applicant: Toyota Jidosha Kabushiki Kaisha, Toyota-shi (JP)

(72) Inventors: Takayuki YAMABE, Tokyo (JP); Aya Yamada Kamisaka, Tokyo (JP); Hajime Tojiki, Tokyo (JP); Kota Hoshiba, Tokyo (JP); Ryota Nakanishi, Tokyo (JP)

(73) Assignee: TOYOTA JIDOSHA KABUSHIKI KAISHA, Toyota-shi (JP)

(21) Appl. No.: 19/537,822

(22) Filed: Feb. 12, 2026

(30) Foreign Application Priority Data
Apr. 8, 2025 (JP) 2025-063785

(51) Int. Cl. G06F 21/62; G10L 15/183

(52) U.S. Cl. CPC G06F 21/6245; G10L 15/183

(57) ABSTRACT

First information to be provided to a first user riding in a first vehicle is generated. A relationship between the first user and one or more second users riding together in the first vehicle is estimated based on a result of sensing the interior of the first vehicle. When the first information includes privacy information of the first user, the first information is edited based on the relationship between the first user and the one or more second users such that at least part of the privacy information of the first user is not included, and the edited first information is output.

### CROSS-REFERENCE TO RELATED APPLICATION

This application claims priority to Japanese Patent Application No. 2025-063785 filed on Apr. 8, 2025. The disclosure of the above-identified application, including the specification, drawings, and claims, is incorporated by reference herein in its entirety.

### BACKGROUND

1. Technical Field

The present disclosure relates to dialogue technology.

### 2. Description of Related Art

Systems have been provided that enable voice-based dialogue in vehicles. For example, Japanese Unexamined Patent Application Publication No. 2001-195430 (JP 2001-195430 A) discloses a system in which artificial intelligence (AI) agents corresponding to users engage in pseudo-conversations with each other.

### SUMMARY

With future advances in machine learning, services that enable dialogue in natural language are expected to become increasingly widespread.

An object of the present disclosure is to protect privacy in a voice-based dialogue system.

One aspect of an embodiment of the present disclosure relates to an information processing device including a control unit configured to: generate first information to be provided to a first user riding in a first vehicle; estimate, based on a result of sensing the interior of the first vehicle, a relationship between the first user and one or more second users riding together in the first vehicle; and when the first information includes privacy information of the first user, perform, based on the relationship between the first user and the one or more second users, editing of the first information such that at least part of the privacy information of the first user is not included, and output information resulting from the editing.

Other aspects provide a method executed by the above device, a program that causes a computer to execute the method, and a computer-readable storage medium that stores the program in a non-transitory manner.

With the present disclosure, it is possible to protect privacy in a voice-based dialogue system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a dialogue system according to a first embodiment;

FIG. 2 is a configuration diagram of an in-vehicle device according to the first embodiment;

FIG. 3A shows an example of a feature database and a relationship database;

FIG. 3B shows another example of a feature database and a relationship database;

FIG. 4 is a diagram showing a flow of processing executed by a control unit of the in-vehicle device;

FIG. 5 is a flowchart of processing executed by the control unit of the in-vehicle device; and

FIG. 6 is a second flowchart of processing executed by the control unit of the in-vehicle device.

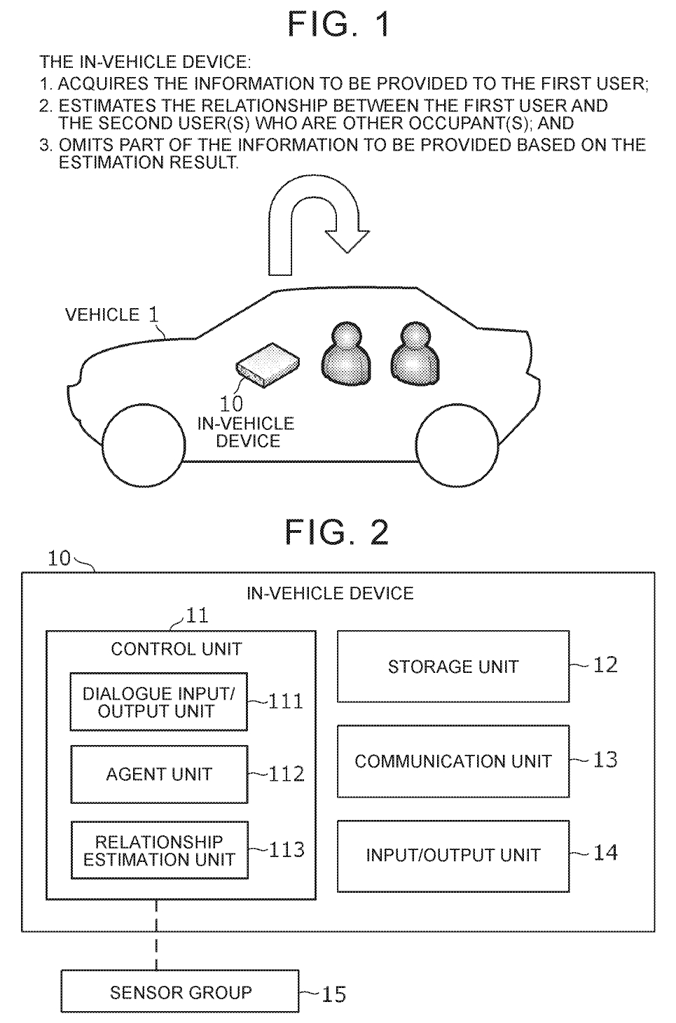

### DETAILED DESCRIPTION OF EMBODIMENTS

In recent years, advances in machine learning have increased the number of products equipped with language models. For example, a natural-language dialogue function can be added to a target product by incorporating into the product a large language model (LLM) whose accuracy has been improved through machine learning using a large-scale dataset.

An automobile is an example in which dialogue in natural language is useful. For example, by equipping an in-vehicle device with an LLM, it becomes possible to obtain information without operating a touch panel or the like. Such a function is particularly useful when the user's hands are occupied, such as while driving. In addition, by having the vehicle make an utterance, information can be proactively provided to the occupants.

There are also attempts to provide a language model for each vehicle occupant and to personalize it. For example, by enabling dialogue using a language model trained on personal information and individual preferences, it is expected that more finely tailored services can be provided to vehicle occupants.

However, when information is provided using a personalized language model, there are cases where information related to the target user's privacy is output. In the case of providing information in a vehicle that may carry multiple occupants, it is preferable to select which information to output in consideration of privacy.

An information processing device according to a first aspect of the present disclosure includes a control unit configured to: generate first information to be provided to a first user riding in a first vehicle; estimate, based on a result of sensing the interior of the first vehicle, a relationship between the first user and one or more second users riding together in the first vehicle; and when the first information includes privacy information of the first user, perform, based on the relationship between the first user and the one or more second users, editing of the first information such that at least part of the privacy information of the first user is not included, and output information resulting from the editing.

The information processing device may be, for example, a device mounted in a vehicle (an in-vehicle device). The information processing device may provide first information to an occupant (the first user) in response to a request from the occupant. The information processing device may provide information by using a language model that engage in dialogue based on personal information or personal data of the first user, that is, a language model personalized for the first user.

The control unit estimates a relationship between the first user and the one or more second users riding together in the first vehicle, based on a result of sensing the occupants riding in the vehicle. The processing for estimating the relationship may be performed, for example, based on a result of identifying the occupants of the vehicle and a database defining relationships among persons. For example, the database may represent, for each pair of occupants, a plurality of predefined relationships such as "family," "married couple," "parent and child," and "work-related."

When the information to be provided to the first user includes privacy information of the first user, the control unit performs, based on the relationship between the first user and the second user(s) (that is, other occupant(s)), editing of the first information such that at least part of the privacy information of the first user is not included, and outputs information resulting from the editing.

The privacy information of the first user typically refers to information for which disclosure should be restricted, such as the first user's personal information or information related to the first user's past behavior. For example, when the first user and the second user are strangers, it may be preferable not to include personal information of the first user (e.g., home location) in the utterance made by the device toward the first user. On the other hand, when the first user and the second user are family members, it may be acceptable for the device to make an utterance that includes personal information. In this way, the control unit determines which information is not to be output based on the estimated relationship between the first user and the second user. With such a configuration, it becomes possible to provide information while protecting privacy.

The control unit may be configured to, when the relationship between the first user and the one or more second users is unknown, perform editing that deletes the privacy information of the first user from the first information. For example, when the relationship between the users is unknown, the first information may be edited such that none of the first user's privacy information is included in the information to be provided.

The types of information to be excluded in the editing may be defined in a database for each relationship between persons. For example, which types of information are to be excluded may be defined for each relationship such as "family," "married couple," "parent and child," or "colleague."

The control unit may be configured to, when the relationship between the first user and the one or more second users is unknown, estimate the relationship between the first user and the one or more second users based on a conversation occurring inside the first vehicle.

Hereinafter, specific embodiments of the present disclosure will be described with reference to the drawings. The hardware configurations, module configurations, functional configurations, and the like described in the embodiments are not intended to limit the technical scope of the disclosure to those configurations unless otherwise specified.

### FIRST EMBODIMENT

### System Overview

An overview of a dialogue system according to a first embodiment will be described. The dialogue system according to the present embodiment includes an in-vehicle device 10 mounted in a vehicle 1. The in-vehicle device 10 is a device capable of providing a dialogue service in natural language using a virtual agent.

A virtual agent is a program that can engage in dialogue in natural language and can be executed by the in-vehicle device 10. By executing a virtual agent on the in-vehicle device 10, the occupants of the vehicle can receive an information provision service in natural language at any desired timing.

The virtual agent can behave as different agents by loading different language models for each of multiple persons riding in the vehicle 1. For example, in a case where there are four persons who regularly ride in the vehicle 1, the in-vehicle device 10 may store four corresponding language models. In such a case, the in-vehicle device 10 can provide information using the language model corresponding to the person riding in the vehicle. Each language model may contain data related to that individual's private matters and may be configured to provide personalized suggestions etc.

The in-vehicle device 10 is mounted in a connected vehicle that can communicate with various devices via wireless communication. The in-vehicle device 10 may include a data communication module (DCM) for connecting components of the vehicle (e.g., electronic control units (ECUs) and in-vehicle terminals) to a network. The virtual agent operating on the in-vehicle device 10 can also acquire information from external devices etc. via the network.

The present embodiment illustrates an example in which the in-vehicle device 10 executes a virtual agent corresponding to a first user riding in the vehicle. The first user is, for example, the driver of the vehicle. Other occupant(s) of the same vehicle are referred to as a second user(s). In this case, the virtual agent corresponding to the first user may output private information about the first user during dialogue. This is undesirable when another occupant (a second user) is present in the vehicle. Accordingly, in the present embodiment, the in-vehicle device 10 identifies the multiple occupants riding in the vehicle, estimates their relationships, and, based on the estimation result, filters out part of the information to be provided (for example, private information about the first user).

### Device Configuration

Next, configurations of the devices that constitute the system will be described. FIG. 2 is a schematic diagram illustrating an example of the configuration of the vehicle 1 according to the present embodiment.

The in-vehicle device 10 can be configured as a computer that includes a processor (a central processing unit (CPU), a graphics processing unit (GPU), etc.), a main storage device (random access memory (RAM), read-only memory (ROM), etc.), and an auxiliary storage device (erasable programmable read-only memory (EPROM), hard disk drive, removable medium, etc.). The auxiliary storage device stores an operating system (OS), various programs, various tables, etc. Various functions (software modules) for predetermined purposes, as described later, can be implemented by executing the programs stored in the auxiliary storage device. However, part or all of the functions may alternatively be implemented as hardware modules by using hardware circuits such as application-specific integrated circuits (ASICs) or field-programmable gate arrays (FPGAs).

The in-vehicle device 10 includes, as hardware components, a control unit 11, a storage unit 12, a communication unit 13, and an input/output unit 14. The in-vehicle device 10 is also connected to a sensor group 15 provided in the vehicle 1.

The control unit 11 is a computing unit that implements various functions of the in-vehicle device 10 by executing predetermined programs. The control unit 11 can be implemented by, for example, a hardware processor such as a CPU. The control unit 11 may include RAM, ROM, and cache memory.

In the present embodiment, the control unit 11 of the in-vehicle device 10 includes three software modules: a dialogue input/output unit 111, an agent unit 112, and a relationship estimation unit 113. Each software module may be implemented by the control unit 11 (e.g., the CPU) executing a program stored in the storage unit 12. The information processing executed by the software modules is equivalent to the information processing executed by the control unit 11 (e.g., the CPU).

The dialogue input/output unit 111 acquires utterances made by the vehicle occupants via the input/output unit 14. The dialogue input/output unit 111 performs predetermined processing on the acquired audio data and executes speech recognition. The content of the utterance is thus converted into text. The dialogue input/output unit 111 then sends the text obtained through the speech recognition to the agent unit 112.

The dialogue input/output unit 111 also outputs the response sent from the agent unit 112. The dialogue input/output unit 111 converts the response output by the language model into audio and outputs it via the input/output unit 14.

The agent unit 112 provides a dialogue service using a language model. By providing a dialogue service using a language model, the agent unit 112 can behave as a virtual agent. The virtual agent may be implemented, for example, by a combination of a program (dialogue engine) and a language model. In the present embodiment, different language models are used for each occupant. For example, the agent unit 112 can behave as a virtual agent for user A by using the language model corresponding to user A, and can behave as a virtual agent for user B by using the language model corresponding to user B.

In the present embodiment, these language models are stored in the storage unit 12 described later. The agent unit 112 can set up a virtual agent by acquiring, for example, the language model corresponding to the driver from the storage unit 12.

When dialogue involves specialized knowledge, the agent unit 112 may also acquire information from one or more external devices available via a network. For example, when it is determined that the occupant who made the utterance is seeking information about a facility or store, the agent unit 112 may access an external language model that is accessible via a network and capable of providing local information, and acquire information.

Based on information acquired from the relationship estimation unit 113 described later, the agent unit 112 estimates the relationships among multiple persons riding in the same vehicle, and filters out part of the response to be output, based on the estimation result. This processing will be described in detail later.

The relationship estimation unit 113 identifies multiple persons riding in the vehicle 1 and estimates their relationships. For example, the relationship estimation unit 113 identifies the person to whom the virtual agent is about to provide information (the first user) and one or more other occupants (second users), based on sensor data output from a plurality of sensors included in the sensor group 15 (described later) and a feature database (described later) that stores feature values of persons, and acquires their identifiers. The relationship estimation unit 113 then estimates the relationship between the first user and the second user(s) by using the acquired identifiers and a relationship database (described later) that defines relationships between occupants. For example, it is herein assumed that three users, user A, user B, and user C, are riding in the vehicle, and the virtual agent is about to provide information to user A. In this case, the relationship estimation unit 113 acquires the identifiers of each user based on biometric information, image information, etc. obtained from sensors, and searches the relationship database using those identifiers as keys. Based on the obtained results, the relationship estimation unit 113 estimates, for example, that "user A and user B are a married couple" and that "user A and user C (user B and user C) are in a parent-child relationship." The estimation result is sent to the agent unit 112 and used for filtering the response.

The identification of persons riding in the vehicle may be performed based on biometric information, facial images, etc. acquired via sensors, or may be performed using other additional information. For example, when each occupant of the vehicle 1 carries a mobile terminal, the persons riding in the vehicle may be identified based on the result of short-range wireless communication with the mobile terminals.

The storage unit 12 is means for storing information, and is configured by a storage medium such as RAM, a magnetic disk, or flash memory. The storage unit 12 stores programs executed by the control unit 11 and data used by the programs.

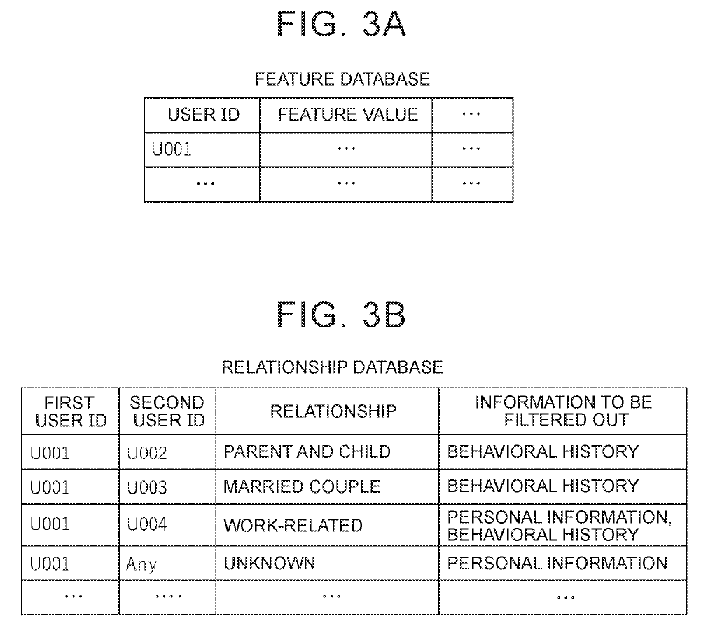

The storage unit 12 also stores the feature database and the relationship database described above. FIG. 3A illustrates an example of the feature database. In the feature database, feature values obtained from sensor data are stored in association with personal identifiers (user IDs). FIG. 3B illustrates an example of the relationship database. In the relationship database, pairs of personal identifiers, identifiers indicating the relationship between them, and the type(s) of information to be filtered out are stored in association with each other. In the illustrated example, the person with the identifier U001 and the person with the identifier U002 are defined as being in a parent-child relationship, and information related to behavioral history is defined as a type of information to be filtered out.

The communication unit 13 includes a communication module that performs wireless communication with a predetermined network (for example, a wide-area network such as the Internet). In the present embodiment, the communication unit 13 is configured to communicate with a predetermined mobile communication network. The communication unit 13 may include an embedded Universal Integrated Circuit Card (eUICC) (for example, a Subscriber Identity Module (SIM) card). The in-vehicle device 10 can communicate with external devices through the communication unit 13.

The input/output unit 14 is a unit that receives input from a user of the device and presents information to the user. The input/output unit 14 typically includes devices that input and output audio, such as a microphone and a speaker. The input/output unit 14 may also include a device that provides visual information (for example, a display).

The sensor group 15 is a collection of multiple sensors provided in the vehicle 1. The sensors are not limited to any particular type as long as they can acquire data for identifying persons riding in the vehicle, such as image sensors and biometric sensors. Means for performing personal identification by communicating with mobile terminals present in the vehicle cabin may also be included in the sensor group 15.

The configuration shown in FIG. 2 is merely an example, and all or part of the illustrated functions may be implemented using dedicated circuits. The programs may be stored or executed using any combination of main and auxiliary storage devices other than those shown in the figure.

### Processing Flow

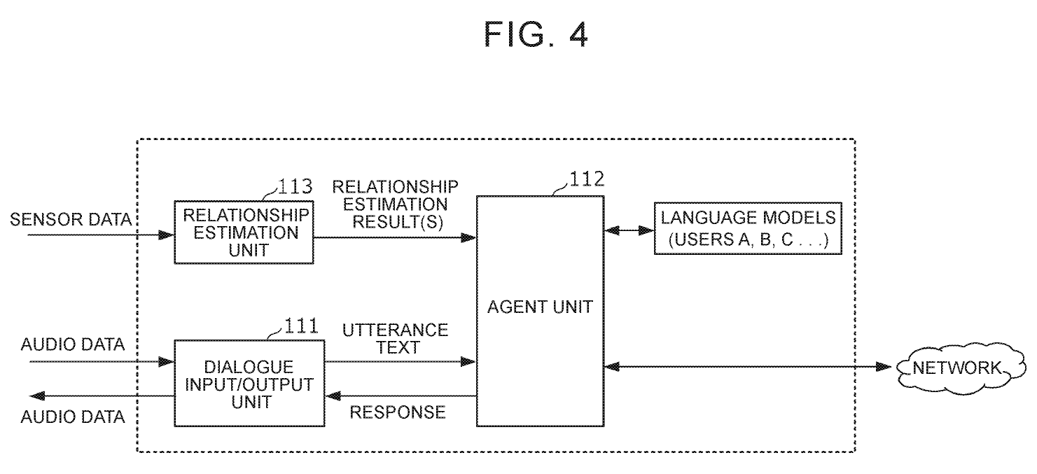

Next, an overview of the processing executed by the control unit 11 will be described. FIG. 4 is a diagram illustrating the flow of processing executed by the control unit 11 of the in-vehicle device 10.

The dialogue input/output unit 111 acquires an utterance from a vehicle occupant via the input/output unit 14. For example, the input/output unit 14 converts the utterance acquired through a microphone into audio data, and the dialogue input/output unit 111 acquires this audio data. The dialogue input/output unit 111 executes predetermined speech recognition processing on the acquired audio data and converts the audio data into text. The dialogue input/output unit 111, while withholding a response to the utterance, sends the text obtained through the speech recognition to the agent unit 112. This text will be hereinafter referred to as "utterance text."

For example, when the content of the utterance text is a request to activate the virtual agent, the agent unit 112 activates the virtual agent in response to the utterance by using the language model corresponding to the occupant who made the utterance.

When the content of the utterance text is a request for dialogue with the virtual agent, the agent unit 112 generates a response using the language model corresponding to the occupant who made the utterance. For example, in a case where the virtual agent being executed corresponds to user A, the agent unit 112 transfers the utterance text to the language model corresponding to user A. When it is determined that the language model corresponding to user A cannot provide sufficient information, the agent unit 112 may instead transfer the utterance text to an external language model (remote language model) via a network. The agent unit 112 acquires the response generated based on the utterance text by the corresponding language model.

The processing executed by the relationship estimation unit 113 will now be described. The relationship estimation unit 113 identifies multiple persons (the first user and the second user(s)) riding in the vehicle 1 based on sensor data output from the sensors included in the sensor group 15. The identification of persons may be performed, for example, based on the result of searching the feature database using feature values obtained by converting the sensor data. The relationship estimation unit 113 then estimates the relationships between the first user and one or more second users based on the identification results. The relationship estimation may be performed, for example, based on the result of searching the relationship database using the personal identifiers corresponding to the occupants. The estimation result is sent to the agent unit 112.

The estimation result includes information such as "User A, user B, and user C are riding in the vehicle; user A is the first user, user A and user B are estimated to be a married couple, and user A and user C are estimated to be in a parent-child relationship."

Returning now to the description of the agent unit 112. After acquiring the response, the agent unit 112 determines whether the response contains personal data of the occupant to whom the information is to be provided. In the present embodiment, "personal data" refers to data related to an individual's privacy, or data that contains private information. For example, suggestions such as "You haven't been to this store for a week," or "This is your second visit to this store. Would you like to check in to earn visit points?" contain personal data. In addition, for example, a response from the language model such as "I searched for ○○ around your home" also contains personal data.

The agent unit 112 may also determine what types of personal data are contained in the response output by the language model. Examples of types of personal data include "personal information" and "behavioral history."

When the response output by the language model contains personal data, the agent unit 112 determines whether to filter the information, based on the type of the personal data. For example, when it is determined based on the relationship database shown in FIG. 3B that a work-related person is also riding in the same vehicle, "personal information" and "behavioral history" are the types of information to be filtered out. The agent unit 112 filters out, from the response output by the language model, the personal data such as personal information and behavioral history, and outputs the resulting information.

Filtering of the response refers to a process of editing the response such that it does not contain personal data. The editing may simply involve deleting the text containing personal data, or may involve rephrasing the text containing personal data in a different way. For example, when the text to be output is "This is your second visit to this store. Would you like to check in to earn visit points?," the filtering may involve deleting the entire text, or may involve replacing it with an expression that does not contain personal data, such as "You can earn visit points at this store. Would you like to check in to earn points?" In this manner, the filtering method is not particularly limited as long as personal data can be removed from the information to be output.

### Flowchart

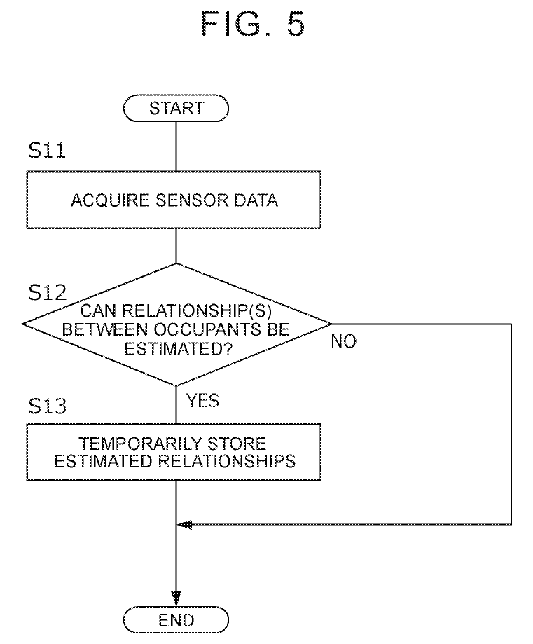

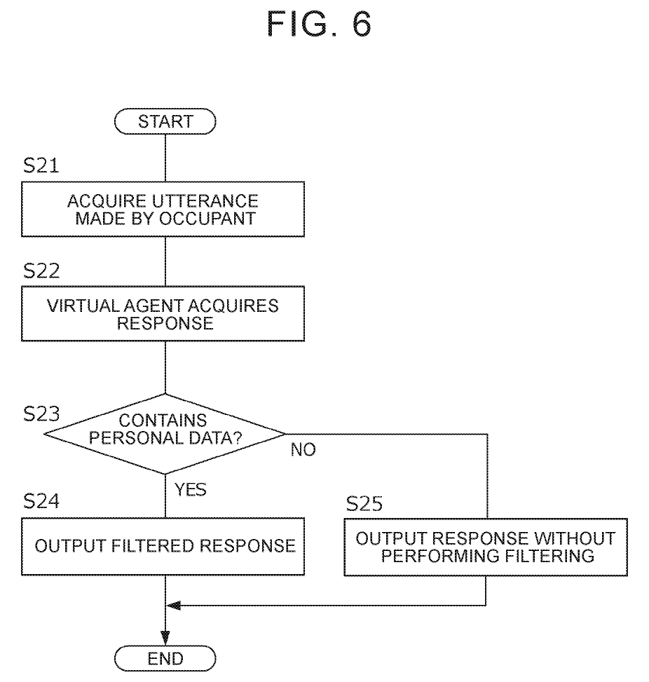

Next, the processing executed by the in-vehicle device 10 will be described in detail. FIG. 5 is a flowchart illustrating the processing executed by the in-vehicle device 10. The processing shown in FIG. 5 determines the relationships among multiple occupants riding in the vehicle in which the virtual agent is being executed. This processing may be executed periodically while the virtual agent is being executed, or may be executed each time a boarding or alighting event occurs in the vehicle 1. In the illustrated processing, it is assumed that the virtual agent corresponding to the first user is being executed by the in-vehicle device 10.

First, in step S11, the relationship estimation unit 113 acquires sensor data for identifying the occupants of the vehicle. The relationship estimation unit 113 may acquire sensor data from the sensors included in the sensor group 15. The occupants of the vehicle may also be identified using information other than sensor data. For example, the relationship estimation unit 113 may identify the occupants of the vehicle by communicating with mobile terminals carried by the occupants via a unit or module for short-range communication.

Next, in step S12, the relationship estimation unit 113 identifies the first user and the second user(s) based on the data acquired in step S11, and determines whether the relationship(s) between the first user and the second user(s) can be estimated. Here, the relationship(s) between the occupant corresponding to the virtual agent being executed (the first user) and other occupant(s) (the second user(s)) are the estimation target(s). For example, when the virtual agent corresponding to user A is being executed and users B and C are other occupants, the combinations "user A and user B" and "user A and user C" are the estimation targets. When the relationships for all the combinations that are the estimation targets can be estimated, the processing proceeds to step S13. In step S13, the estimated relationships are temporarily stored. When the estimation fails in step S12, the processing ends. In this case, information indicating that the estimation has failed may be temporarily stored.

Next, dialogue processing will be described in detail. FIG. 6 is a flowchart illustrating the dialogue processing executed by the in-vehicle device 10. This processing starts when an utterance is made by an occupant.

First, in step S21, the dialogue input/output unit 111 acquires the utterance made by the occupant. The dialogue input/output unit 111 acquires audio data output from the input/output unit 14 and executes speech recognition processing to convert the utterance into text. The converted text (utterance text) is sent to the agent unit 112.

In step S22, the agent unit 112 inputs the utterance text to the language model corresponding to the occupant who made the utterance (the first user), and acquires a response to the utterance text.

In step S23, the agent unit 112 determines whether the response to be output contains personal data of the first user. When the response to be output contains the personal data of the first user, the processing proceeds to step S24. When the response to be output does not contain the personal data of the first user, the processing proceeds to step S25.

In step S24, the agent unit 112 performs filtering of the response based on information regarding the occupants' relationships acquired from the relationship estimation unit 113. In this step, it is determined whether the identified relationship is defined in the relationship database, and when the relationship is defined in the relationship database, the corresponding type(s) of information is filtered out. For example, in the example of FIG. 3B, when it is determined that the first user and the second user are a married couple, the information related to the behavioral history of the first user is the type of information to be filtered out. In this case, the personal information of the first user is not the type of information to be filtered out. The agent unit 112 then outputs the filtered response.

When the processing proceeds to step S25, the agent unit 112 outputs the response without performing information filtering.

As described above, in the in-vehicle device according to the first embodiment, when multiple occupants are riding in the same vehicle, their relationships are estimated, and part of the information to be provided to a specific occupant is filtered out based on the estimation result. This configuration reduces the likelihood that private information will be disclosed to other occupants.

Although the present embodiment illustrates an example in which the agent unit 112 outputs a response to an occupant's utterance, the agent unit 112 may provide information on its own without being triggered by an utterance. For example, when a predetermined condition is satisfied, the agent unit 112 may generate and output information recommending a visit to a specific location. Even in such a case, filtering can be performed in the same manner as described above.

### Modifications of First Embodiment

In the first embodiment, the in-vehicle device 10 uses a relationship database in which the relationships between the first user who is to receive information and the second user(s) who are other occupant(s) of the same vehicle are predefined. The relationship database may also be updated based on sensing results.

For example, the in-vehicle device 10 may record, for a certain period of time, conversations occurring inside the vehicle by using a microphone included in the sensor group 15, and may acquire the content of utterances for each occupant. The relationships among the occupants may then be estimated based on the content of utterances. For example, when another user (user B) responds to the call made by a user (user A), it may be possible to estimate the relationship between user A and user B based on the content of the call or the form of address used. For example, when the relationships among the occupants cannot be determined in step S12, the corresponding relationships may be estimated based on the recorded conversation. The estimation of the relationships based on conversations may be performed using any known technique.

### Modifications

The above embodiment is merely an example, and the present disclosure may be modified as appropriate without departing from the spirit and scope of the disclosure. For example, the processes and means described in the present disclosure may be combined as desired as long as no technical contradiction occurs.

The embodiment illustrates an example in which information to be provided to the vehicle occupant is generated by a language model. However, the source of the information provided by the in-vehicle device 10 is not limited to language models. For example, when any application software is executable on the in-vehicle device 10, information output by such application software may be provided to the vehicle occupant. In this case, the information output by the application software is subject to filtering. In addition, in this case, a unit or module that manages execution of the application software may estimate the relationships among the occupants and perform information filtering.

The processing described as being executed by a single device may instead be shared and executed by a plurality of devices. Alternatively, the processing described as being executed by different devices may be executed by a single device. In a computer system, the hardware configuration (server configuration) used to implement each function may be modified flexibly.

The present disclosure may also be implemented by supplying a computer with a computer program that implements the functions described in the above embodiment, and causing one or more processors included in the computer to read and execute the program. Such a computer program may be provided to the computer via a non-transitory computer-readable storage medium connectable to the system bus of the computer, or may be provided to the computer via a network. Examples of the non-transitory computer-readable storage medium may include any type of disk such as a magnetic disk (floppy (registered trademark) disk, hard disk drive (HDD), etc.), an optical disc (compact disc read-only memory (CD-ROM), digital versatile disc (DVD), Blu-ray disc, etc.), read-only memory (ROM), random access memory (RAM), erasable programmable read-only memory (EPROM), electrically erasable programmable read-only memory (EEPROM), a magnetic card, flash memory, an optical card, and any other type of medium suitable for storing electronic instructions.

What is claimed is:

1. An information processing device comprising a control unit configured to
generate first information to be provided to a first user riding in a first vehicle,
estimate, based on a result of sensing an interior of the first vehicle, a relationship between the first user and one or more second users riding together in the first vehicle, and
when the first information includes privacy information of the first user, perform, based on the relationship between the first user and the one or more second users, editing of the first information such that at least part of the privacy information of the first user is not included, and output information resulting from the editing.

2. The information processing device according to claim 1, wherein the control unit is configured to, when the relationship between the first user and the one or more second users is unknown, perform editing that deletes the privacy information of the first user from the first information.

3. The information processing device according to claim 1, wherein the privacy information of the first user includes personal information of the first user or information related to past behavior of the first user.

4. The information processing device according to claim 1, further comprising a database that stores, for each estimated relationship, a type of information to be excluded in the editing.

5. The information processing device according to claim 1, wherein the control unit is configured to, when the relationship between the first user and the one or more second users is unknown, estimate the relationship between the first user and the one or more second users based on a conversation occurring inside the first vehicle.
